(19) United States
(12) Patent Application Publication
(10) Pub. No.: US 2009/0135266 A1
(43) Pub. Date: May 28, 2009

(54) SYSTEM FOR SCRIBING A VISIBLE LABEL

(75) Inventors: Jeroen Arnoldus Leonardus Raaymakers, Eindhoven (NL); George Alois Leonie Leenknegt, Eindhoven (NL); Jan Verbiest, Geel (BE); Igolt Pieter Douwes Ubbens, Eindhoven (NL)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS, N.V., EINDHOVEN (NL)

(21) Appl. No.: 11/719,307

(22) PCT Filed: Nov. 15, 2005
(86) PCT No.: PCT/IB05/53765

§ 371 Date: May 15, 2007

(30) Foreign Application Priority Data
Dec. 23, 2004 (EP) 04106927.9

(51) Int. Cl. H04N 5/228

(52) U.S. Cl. 348/222.1; 348/E05.031

(57) ABSTRACT

An image processing apparatus (1) receives a color input signal (3) and configurable user settings (7). The image processing apparatus (1) is adapted to transform the color input signal (3) into a modified color signal (9) for display on a color display (11). The image processing apparatus (1) transforms one or more colors in the color input signal (3) to another color or colors, such that the image signal can be viewed by a color blind person. The image processing apparatus (1) may also change the brightness level or texture setting of a particular color in order to make the color more visible to a colorblind person. The image processing apparatus is also adaptable to inform a user of the true color of a particular color in the color input signal.

### TECHNICAL FIELD OF THE INVENTION

The invention relates to an image processing apparatus and method, and in particular to an image processing apparatus and method for displaying color images on a display, for example the display of a portable device.

### BACKGROUND TO THE INVENTION

Portable devices such a mobile phones and PDAs have traditionally displayed images using monochrome displays, mainly due to the processing limitations and the cost requirements of such devices. However, more recently color displays are being used to enhance the information displayed on mobile phones and PDAs. This is being driven by the popularity of camera phones, and also by the introduction of 3G services in which a large amount of information must be conveyed to the user using a relatively small display.

A map is a typical example where color is used as a primary means of imparting information in the content of a displayed image. For example, different types of road markings are shown in different colors, rivers shown in blue, land shown in varying shades of green, and so on. In addition to using color in this way as a means of imparting primary information, color is also used to assist users when navigating menus and selecting information. While the use of color is generally helpful to the majority of users, it can be extremely problematic to people who are color blind.

Color blindness has several forms. People who have full color vision are known as Trichromats. Dichromats are people who can only see two of the three primary colors of light (red, green, blue), while Achromatopsia is the inability to see any colors. These people see life in monochrome, or grays. It will therefore be appreciated that the move from monochrome to color displays in devices such as mobile phones and PDAs can lead to confusion to those who are color blind, particularly when color is being used a primary means of conveying information.

Algorithms have been developed for adapting an image such that colors can be “seen” by people that are colorblind. However, these algorithms involve adapting an image such that a certain color is always changed in a particular way. For example, a certain color is always changed to another color that is more likely to be visible to the user. However, algorithms such as this can lead to problems, for example when a background color is automatically changed to the same color as the text used in the foreground, thereby making the text unreadable. These algorithms are also limited in that they are generic to all people, and may not provide the best solution for a particular user.

Other systems are known in which the colors of a display are changed according to the environment in which the display is being used. However, as above, these systems offer limited benefits to a person that is colorblind.

### SUMMARY OF THE INVENTION

An aim of the present invention is therefore to provide an image processing apparatus and method that mitigates the disadvantages mentioned above. The invention is defined by the independent claims. The dependent claims define advantageous embodiments.

A particular embodiment of the invention relates to an image processing apparatus that is personalized to a particular user, rather than relying on pre-programmed algorithms and/or environmental conditions. The invention has the advantage of allowing people that are color blind to selectively alter how an image is displayed according to their individual needs.

A primary aspect of the invention provides an image processing apparatus for processing a color image signal prior to being displayed, the apparatus comprising means for receiving a color image signal; means for selectively identifying at least one color in the received color image signal; means for creating one or more user configurable settings during a training sequence; and means for dynamically transforming the at least one color prior to being displayed, based on the user configurable settings created during the training sequence.

The apparatus may further comprise means for displaying a test pattern having a plurality of colors to a user during the training sequence; and receiving means for receiving one or more inputs from an user, corresponding to one or more colors in the plurality of colors that require transformation prior to being displayed. The training sequence may comprise the steps of: displaying a test pattern having a plurality of colors to a user; receiving one or more input signals from an user, corresponding to one or more colors in the plurality of colors that require transformation prior to being displayed; re-displaying a modified test pattern having one or more colors transformed in accordance with the input signals; and repeating the above steps until all colors in the test pattern are distinguishable to a user.

The means for dynamically transforming the at least one color may be adapted to change a particular color into a different color, or to change the brightness level of a particular color into a different brightness level, or to change the texture setting of a particular color into a different texture setting.

The apparatus may further comprise means for identifying a particular color to a user.

The apparatus may further comprise means for converting a RGB color signal corresponding to at least a portion of the color image signal into U and V components; means for mapping the U and V components to an output color indicator; and means for informing the user of the output color indicator.

### BRIEF DESCRIPTION OF THE DRAWINGS

For a better understanding of the present invention, and to show more clearly how it may be carried into effect, reference will now be made, by way of example, to the following drawings, in which:

FIG. 1 is a block diagram of an image processing apparatus according to the present invention;

FIG. 2 shows a device for use in configuring the image processing apparatus of FIG. 1 during a training sequence; and

FIG. 3 shows an alternative embodiment of the present invention.

### DETAILED DESCRIPTION OF A PREFERRED EMBODIMENT OF THE INVENTION

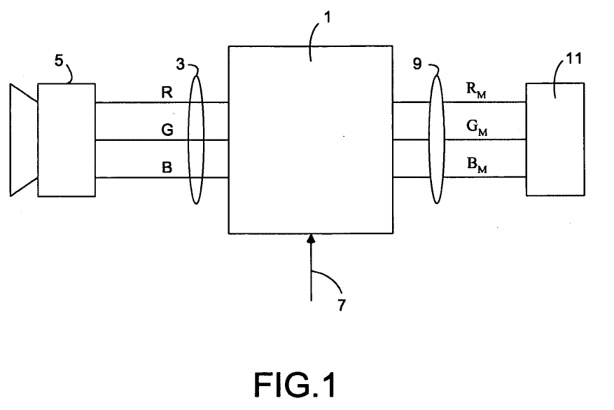

FIG. 1 shows an image processing apparatus according to the present invention. The image processing apparatus 1 receives a color image signal 3, encoded in this embodiment in the form of a RGB signal having the primary components Red, Green and Blue. The embodiment shows the color image signal 3 being received from an image-capturing device such as a camera 5. It will be appreciated, however, that the color image signal 3 could also be received from other sources, including an image signal stored in a data file, an image signal downloaded from a remote source, and so on.

The image processing apparatus 1 receives (e.g. by means of a touch screen display or a keypad device) one or more input signals 7 that form user configurable settings. The user configurable settings are input during a training sequence, as will be described later. The output signal from the image processing apparatus 1 comprises a color signal 9 in which one or more of the Red, Green and Blue components can be transformed or modified (R_{M}G_{M}B_{M}) in accordance with the user configurable settings based on the input signals 7, prior to being displayed on a color display 11.

Based on the user configurable settings, the image processing apparatus 1 dynamically transforms (e.g. by means of a look-up table to identify how the selectively identified color is to be transformed prior to display) the color image signal to an understandable scene for the colorblind person. The image processing apparatus 1 is configured to detect a selected color or colors in the input color scene, and to transform one or more colors based on the user configurable settings. Preferably, the transformation is carried out using a look-up table for pixel-by-pixel translation. Connected regions in the scene can also be given unique, distinguishable colors for the colorblind user, based on the personal settings of the user.

As an alternative to altering a particular color to another color, a particular color can also be modified into a textured surface, for example cross-hatched, thereby avoiding the potential problem of the color being translated into a color that is similar to an existing color in the scene.

As discussed above, the transformation performed by the image processing apparatus 1 is based on the one or more input signals 7 entered by a user during a training sequence, for example in conjunction with the use of a test pattern having a plurality of colors, as will be described in greater detail below.

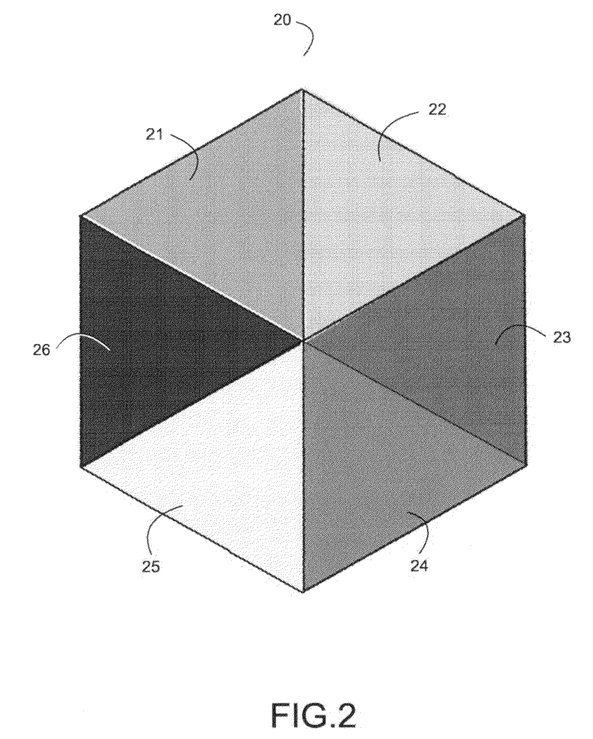

FIG. 2 shows a test pattern 20 having a plurality of colors defined in separate sections. The test pattern may be provided in the form of a card, whereby the user points a camera at the card during a training sequence in order to display the test pattern on the display. Alternatively, the test pattern could be stored in memory, and displayed to the user upon activation of a training sequence.

The test pattern 20 in the illustrated example includes the colors red 21, violet 22, yellow 23, blue 24, green 25 and aqua 26. Each color is separated by black lines so that the user can identify a boundary between two colors.

When the test pattern 20 is displayed on the display 11 during a training sequence (either by pointing a camera device at a test card or retrieving a test pattern from memory), the user is asked to indicate which colors are indistinguishable. This can be done by either pressing the relevant sections on the display 11 (i.e. if the display is a touch-screen display), or by providing each section 21 to 26 with a numeric indicator. In the latter, the user would simply enter the indistinguishable sections using a keypad. This process is repeated until all colors in the test pattern 20 are individually distinguishable to the user.

Based on these input signals entered by a user during the training sequence, a set of user configurable settings will be created, which inform the image processing apparatus about how the color image signal is to be transformed. Preferably, the user configurable settings are used to compile the mapping table described above, which governs how the image processing apparatus will transform one or more colors prior to being displayed to the user.

If during the training sequence the image processing apparatus 1 is unable to provide distinguishable sections 21 to 26 based on adjusting the color values alone, then the image processing apparatus 1 is configured to provide other ways of distinguishing the various colors (i.e. sections). For example, the image processing apparatus can be configured to use texture such as cross-hatching to denote a certain color.

It is noted that greater or fewer colors can be used on the colored test pattern 20 depending on the complexity of the system requirements.

Once the image processing apparatus has been configured using the training sequence described above, the user simply uses the apparatus by pointing the device at an object, and viewing the transformed image on the display. Likewise, any images received from a data file, for example information downloaded from a file for display on the display, will also be transformed in accordance with the user settings.

As a further alternative, or in addition to the above, other parameters of the pixel data can be modified, for example brightness or luminance.

Although the preferred embodiment has been described in relation to a RGB signal in which the RGB components are modified, it will be appreciated that the color image signals 3 and 9 can take other forms, including digital pixel data in which the digital data is modified in accordance with the personal settings of a user. For example, if there are a given set of color values for a particular LCD display (for example some displays having only 256 color values, while others have 65,536 color values), the image processing apparatus could be configured such that a particular color or range of colors in the set of color values are transformed to another color or range of colors based on the user settings configured by the user.

According to another aspect of the invention, the image processing apparatus can also be configured to identify a particular color to a user. For example, in response to the user pointing the device to an item of clothing, and selecting the item of interest from the displayed image, the image processing apparatus can be configured to analyze the color and communicate the real-life color to the user. This aspect of the invention has numerous advantageous applications, for example allowing a user to point the device towards various shirts in a clothes room to identify a particular colored shirt, instead of having to reply on another person to identify a particular shirt.

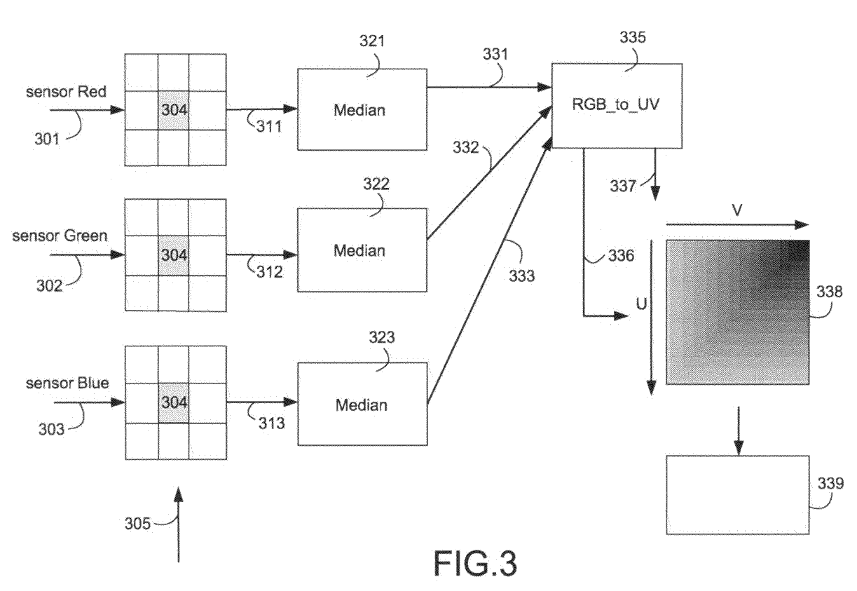

FIG. 3 describes in greater detail an alternative embodiment in accordance with this aspect of the invention. Red, green and blue color signals, 301, 302 and 303, respectively, are analyzed for a predetermined area 304 of a display, for example corresponding to an area 304 selected by a user 305, i.e. by touching the area of the display having the color of interest. The red, green and blue signals 311, 312, 313 corresponding to the small area 304, for example 3×3 pixels, are passed to filters 321, 322, 323 for determining the median of the respective signals. The median signals 331, 332, 333 of the red, green and blue signals are passed to an RGB to UV converter, for converting the RGB signals to U and V coordinates, 336, 337. This process removes the influence of light intensity on the color signals being analyzed.

The U and V coordinates 336, 337 are used to point to a UV table 338, which is adapted to match the U and V coordinates 336, 337 to the closest output color indicator. The apparatus comprises an output device 339 for indicating the closest output color indicator to the user, thus informing the user of the color of the area 304 previously selected on the display. Preferably, the user is informed of the color by means of a visual indicator other than color, for example by means of text written on the display. Alternatively, the user may be informed of the color by means of an audible signal, for example announcing the word “red” to the user.

This further aspect of the invention enables a user to point a portable device such as a mobile phone towards a particular scene, select an area of the displayed image, and then be informed of the true color of the selected color. In addition to determining the color of images viewed from a sensor, the apparatus can also be configured within a device such as a television or a computer screen, thus enabling a user to touch a particular area of the screen, and to be informed of the true color of that area.

A preferred embodiment can be summarized as follows. An image processing apparatus 1 receives a color input signal 3 and configurable user settings 7. The image processing apparatus 1 is adapted to transform the color input signal 3 into a modified color signal 9 for display on a color display 11. The image processing apparatus 1 transforms one or more colors in the color input signal 3 to another color or colors, such that the image signal can be viewed by a color blind person. The image processing apparatus 1 may also change the brightness level or texture setting of a particular color in order to make the color more visible to a colorblind person. The image processing apparatus is also adaptable to inform a user of the true color of a particular color in the color input signal.

Although the preferred embodiments have been described in relation to portable devices such as mobile phones or PDAs, it will be appreciated that the invention can also be used in conjunction with any color display having some means of entering user configurable settings, for example a television or computer as mentioned above.

It should be noted that the above-mentioned embodiments illustrate rather than limit the invention, and that those skilled in the art will be able to design many alternative embodiments without departing from the scope of the appended claims. The word “comprising” does not exclude the presence of elements or steps other than those listed in a claim, “a” or “an” does not exclude a plurality, and a single processor or other unit may fulfill the functions of several units recited in the claims. Any reference signs in the claims shall not be construed so as to limit their scope.

1. An image processing apparatus (1) for processing a color image signal prior to being displayed, the apparatus comprising:
means for receiving a color image signal (3);
means for selectively identifying at least one color in the received color image signal;
means for creating one or more user configurable settings during a training sequence; and
means for dynamically transforming the at least one color prior to being displayed, based on the user configurable settings created during the training sequence.

2. An apparatus as claimed in claim 1, further comprising:
means (11) for displaying a test pattern having a plurality of colors to a user during the training sequence; and
receiving means for receiving one or more inputs (7) from an user, corresponding to one or more colors in the plurality of colors that require transformation prior to being displayed.

3. An apparatus as claimed in claim 1, wherein the means for dynamically transforming the at least one color is adapted to change a particular color into a different color.

4. An apparatus as claimed in claim 1, wherein the means for dynamically transforming the at least one color is adapted to change the brightness level of a particular color into a different brightness level.

5. An apparatus as claimed in claim 1, wherein the means for dynamically transforming the at least one color is adapted to change the texture setting of a particular color into a different texture setting.

6. An apparatus as claimed in claim 1, further comprising means for identifying a particular color to a user.

7. An apparatus as claimed in claim 9, further comprising:
means (335) for converting a RGB color signal corresponding to at least a portion (304) of the color image signal into U and V components;
means (338) for mapping the U and V components to an output color indicator; and
means (339) for informing the user of the output color indicator.

8. A method of processing a color image signal prior to being displayed on a display device, the method comprising the steps of:
receiving a color image signal that is to be displayed;
selectively identifying at least one color in the received color image signal;
creating one or more configurable user settings during a training sequence; and
dynamically transforming the at least one color prior to being displayed, based on the configurable user settings obtained during the training sequence.

9. A method as claimed in claim 8, wherein the training sequence comprises the steps of:
displaying a test pattern having a plurality of colors to a user;
receiving one or more input signals from an user, corresponding to one or more colors in the plurality of colors that require transformation prior to being displayed;
re-displaying a modified test pattern having one or more colors transformed in accordance with the input signals; and
repeating the above steps until all colors in the test pattern are distinguishable to a user.
